(19) United States
(12) Patent Application Publication
(10) Pub. No.: US 2020/0285985 A1
(43) Pub. Date: Sep. 10, 2020

(54) CONSTANT FOLDING FOR COMPILATION OF QUANTUM ALGORITHMS

(71) Applicant: International Business Machines Corporation, Armonk, NY (US)

(72) Inventor: Ali Javadiabhari, Sleepy Hollow, NY (US)

(73) Assignee: International Business Machines Corporation, Armonk, NY (US)

(21) Appl. No.: 16/296,817

(22) Filed: Mar. 8, 2019

(51) Int. Cl. G06N 10/00; G06F 17/50

(52) U.S. Cl. CPC G06N 10/00; G06F 17/5009

(57) ABSTRACT

A method for constant folding for compilation of quantum algorithms includes forming a first set of quantum gates, the first set of quantum gates arranged to simulate a quantum algorithm. The method further includes determining, after performing a first subset of the first set of quantum gates, a state of a qubit of a quantum processor. The method further includes comparing the state of the qubit to an acceptability criterion. The method further includes removing, in response to determining the state meets an acceptability criterion, a second subset of the set of quantum gates. The method further includes forming, in response to removing the second subset of the set of quantum gates, a second set of quantum gates, the second set of quantum gates arranged to simulate the quantum algorithm.

### TECHNICAL FIELD

The present invention relates generally to a method for quantum computing. More particularly, the present invention relates to a method for constant folding for compilation of quantum algorithms.

### BACKGROUND

Hereinafter, a “Q” prefix in a word of phrase is indicative of a reference of that word or phrase in a quantum computing context unless expressly distinguished where used.

Molecules and subatomic particles follow the laws of quantum mechanics, a branch of physics that explores how the physical world works at the most fundamental levels. At this level, particles behave in strange ways, taking on more than one state at the same time, and interacting with other particles that are very far away. Quantum computing harnesses these quantum phenomena to process information.

The computers we use today are known as classical computers (also referred to herein as “conventional” computers or conventional nodes, or “CN”). A conventional computer uses a conventional processor fabricated using semiconductor materials and technology, a semiconductor memory, and a magnetic or solid-state storage device, in what is known as a Von Neumann architecture. Particularly, the processors in conventional computers are binary processors, i.e., operating on binary data represented in 1 and 0.

A quantum processor (q-processor) uses the odd nature of entangled qubit devices (compactly referred to herein as “qubit,” plural “qubits”) to perform computational tasks. In the particular realms where quantum mechanics operates, particles of matter can exist in multiple states—such as an “on” state, an “off” state, and both “on” and “off” states simultaneously. Where binary computing using semiconductor processors is limited to using just the on and off states (equivalent to 1 and 0 in binary code), a quantum processor harnesses these quantum states of matter to output signals that are usable in data computing.

Conventional computers encode information in bits. Each bit can take the value of 1 or 0. These 1s and 0s act as on/off switches that ultimately drive computer functions. Quantum computers, on the other hand, are based on qubits, which operate according to two key principles of quantum physics: superposition and entanglement. Superposition means that each qubit can represent both a 1 and a 0 at the same time. Entanglement means that qubits in a superposition can be correlated with each other in a non-classical way; that is, the state of one (whether it is a 1 or a 0 or both) can depend on the state of another, and that there is more information that can be ascertained about the two qubits when they are entangled than when they are treated individually.

Using these two principles, qubits operate as more sophisticated processors of information, enabling quantum computers to function in ways that allow them to solve difficult problems that are intractable using conventional computers. IBM has successfully constructed and demonstrated the operability of a quantum processor using superconducting qubits (IBM is a registered trademark of International Business Machines corporation in the United States and in other countries.)

A superconducting qubit includes a Josephson junction. A Josephson junction is formed by separating two thin-film superconducting metal layers by a non-superconducting material. When the metal in the superconducting layers is caused to become superconducting—e.g. by reducing the temperature of the metal to a specified cryogenic temperature—pairs of electrons can tunnel from one superconducting layer through the non-superconducting layer to the other superconducting layer. In a qubit, the Josephson junction—which functions as a dispersive nonlinear inductor—is electrically coupled in parallel with one or more capacitive devices forming a nonlinear microwave oscillator. The oscillator has a resonance/transition frequency determined by the value of the inductance and the capacitance in the qubit circuit. Any reference to the term “qubit” is a reference to a superconducting qubit circuitry that employs a Josephson junction, unless expressly distinguished where used.

The information processed by qubits is carried or transmitted in the form of microwave signals/photons in the range of microwave frequencies. The microwave signals are captured, processed, and analyzed to decipher the quantum information encoded therein. A readout circuit is a circuit coupled with the qubit to capture, read, and measure the quantum state of the qubit. An output of the readout circuit is information usable by a q-processor to perform computations.

A superconducting qubit has two quantum states—|0> and |1>. These two states may be two energy states of atoms, for example, the ground (|g>) and first excited state (|e>) of a superconducting artificial atom (superconducting qubit). Other examples include spin-up and spin-down of the nuclear or electronic spins, two positions of a crystalline defect, and two states of a quantum dot. Since the system is of a quantum nature, any combination of the two states are allowed and valid.

For quantum computing using qubits to be reliable, quantum circuits, e.g., the qubits themselves, the readout circuitry associated with the qubits, and other parts of the quantum processor, must not alter the energy states of the qubit, such as by injecting or dissipating energy, in any significant manner or influence the relative phase between the |0> and |1> states of the qubit. This operational constraint on any circuit that operates with quantum information necessitates special considerations in fabricating semiconductor and superconducting structures that are used in such circuits.

In conventional circuits, Boolean logic gates arranged in succession manipulate a series of bits. The technology for optimizing the gate-logic for binary computations is well-known. Circuit optimization software for conventional circuits aims to increase efficiency and decrease complexity of conventional circuits. Circuit optimization software for conventional circuits functions in part by decomposing the overall desired behavior of the conventional circuit into simpler functions. The conventional circuit optimization software more easily manipulates and processes the simpler functions. The circuit optimization software generates an efficient layout of design elements on the conventional circuit. As a result, circuit optimization software for conventional circuits significantly reduces resource demands, thereby increasing efficiency and decreasing complexity.

The illustrative embodiments recognize that in quantum circuits, quantum gates manipulate qubits to perform quantum computations. Quantum gates are unitary matrix transformations acting on qubits. Due to the superposition and entanglement of qubits, quantum gates represent a 2ⁿ by 2ⁿ matrix, where n is the number of qubits the quantum gate manipulates. The illustrative embodiments recognize that the decomposition of such matrix transformations quickly becomes too complex to perform by hand due to the exponential increase in the size of the matrix transformations with the number of qubits. For example, quantum computers with 2 qubits require a 4 by 4 matrix operator for quantum gate representation. A quantum computer with 10 qubits require a 1024 by 1024 matrix operator for quantum gate representation. As a result of the exponential increase, manual quantum logic gate matrix transformations quickly become unmanageable as the number of qubits increases.

Circuit optimization for quantum circuits depends on the chosen function, resource requirements, and other design criteria for the quantum circuit. For instance, quantum circuits are often optimized to work with a specific device. Therefore, there is a need for improved methods for compilation methods of quantum circuits.

A quantum algorithm represents a set of instructions to be performed on a quantum computer. The illustrative embodiments recognize that quantum algorithms can be modeled as a quantum circuit. A quantum circuit is a computation model formed of a set of quantum logic gates which perform the steps of the corresponding quantum algorithm.

In conventional computations, a classical algorithm can be simplified if the compiler determines a given variable is constant across all instructions. Constant folding is the process of recognizing and evaluating constant expressions at compile time rather then computing the constant expressions at runtime. Constant folding in conventional computers involves identifying constant expressions and replacing the constant expressions with the computed values from compile time and removing redundant operations to save computing resources.

Dead code elimination is the process of removing code from a classical algorithm which does not affect results. Elimination of dead code avoids executing irrelevant operations and reduces runtime, thereby improving efficiency of the conventional circuit.

The illustrative embodiments recognize that all qubits are initialized by putting the qubits in basis state |0>. Quantum logic gates manipulate the qubits and alter the state of the qubits. The illustrative embodiments further recognize that manipulation of the qubits may render the state of the qubit in one of the basis states, |0> or |1>. The illustrative embodiments further recognize that the set of logic gates which render the state of the qubit in one of the basis states can be either removed from the quantum circuit (if the basis state is |0>) or replaced with a Pauli-X gate (if the basis state is |1>), to flip the qubit from the initialized state to the new basis state.

Quantum fidelity is a measure of the “closeness” or overlap of two quantum states. Quantum fidelity serves as a test to determine whether one quantum state will pass a test to identify as another quantum state. The illustrative embodiments recognize that certain quantum gates provide very little manipulation of a quantum state. For example, the quantum fidelity of two qubit states, one before a quantum gate and one after the quantum gate, may be ninety-seven percent or more.

The illustrative embodiments further recognize that quantum gates contain error rates which affect the computation of the quantum algorithm. Each quantum gate introduces quantum noise into the quantum system which affects the state of the qubit. Quantum gate error corresponds to how accurately the quantum processor controls the superposition of states of the qubit(s) acted on by the quantum gate. The illustrative embodiments further recognize that a quantum gate error can exceed the quantum fidelity of the quantum states before and after the quantum gate.

The illustrative embodiments recognize that hardware resources for quantum processors are limited. The illustrative embodiments further recognize that compilers which transform a quantum algorithm to a quantum circuit to be executed on a quantum processor aim to create circuits which are functionally equivalent to the quantum algorithm but run with maximum efficiency on the quantum hardware. The illustrative embodiments further recognize that elimination of extraneous or unnecessary operations simplifies and creates a more efficient quantum circuit.

### SUMMARY

The illustrative embodiments provide a method for constant folding for compilation of quantum algorithms. A method of an embodiment includes forming a first set of quantum gates, the first set of quantum gates arranged to simulate a quantum algorithm. In an embodiment, the method further includes determining, after performing a first subset of the first set of quantum gates, a state of a qubit of a quantum processor.

In an embodiment, the method further includes comparing the state of the qubit to an acceptability criterion. In an embodiment, the method further includes removing, in response to determining the state meets an acceptability criterion, a second subset of the set of quantum gates. In an embodiment, the method further includes forming, in response to removing the second subset of the set of quantum gates, a second set of quantum gates, the second set of quantum gates arranged to simulate the quantum algorithm.

In an embodiment, the method further includes removing the first subset of the first set of quantum gates to form the second set of quantum gates. In an embodiment, the method further includes removing the subset of the first set of quantum gates to form the second set of quantum gates.

In an embodiment, the method further includes determining, in response to determining the state meets an acceptability criterion, a subset of the first set of quantum gates are extraneous quantum gates. In an embodiment, the method further includes removing the subset of quantum gates from the first set of quantum gates.

In an embodiment, the method further includes executing the quantum algorithm with the second set of quantum gates. In an embodiment, the acceptability criterion is a conditional statement for a quantum gate of the first set of quantum gates.

An embodiment includes a computer usable program product. The computer usable program product includes a computer-readable storage device, and program instructions stored on the storage device.

In an embodiment, the computer usable code is stored in a computer readable storage device in a data processing system, and wherein the computer usable code is transferred over a network from a remote data processing system. In an embodiment, the computer usable code is stored in a computer readable storage device in a server data processing system, and wherein the computer usable code is downloaded over a network to a remote data processing system for use in a computer readable storage device associated with the remote data processing system

An embodiment includes a computer system. The computer system includes a processor, a computer-readable memory, and a computer-readable storage device, and program instructions stored on the storage device for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example configuration of constant folding for compilation of quantum algorithms in accordance with an illustrative embodiment;

FIG. 4 depicts an example reconfiguration step in accordance with an illustrative embodiment;

FIG. 5 depicts an example reconfiguration step in accordance with an illustrative embodiment;

FIG. 6 depicts a flowchart of an example method for constant folding for compilation of quantum algorithms in accordance with an illustrative embodiment.

### DETAILED DESCRIPTION

The illustrative embodiments used to describe the invention generally address and solve the above-described needs for reducing redundant operations on qubits and quantum gates in a quantum processor. The illustrative embodiments provide a method for constant folding for compilation of quantum algorithms.

An embodiment provides a method for improving compilation of a quantum circuit model of a quantum algorithm using a hybrid classical-quantum computing system. Another embodiment provides a conventional or quantum computer usable program product comprising a computer-readable storage device, and program instructions stored on the storage device, the stored program instructions comprising a method for improving compilation of a quantum circuit model using a hybrid classical-quantum computing system. The instructions are executable using a conventional or quantum processor. Another embodiment provides a computer system comprising a conventional or quantum processor, a computer-readable memory, and a computer-readable storage device, and program instructions stored on the storage device for execution by the processor via the memory, the stored program instructions comprising a method for improving compilation of a quantum circuit model using a hybrid classical-quantum computing system.

One or more embodiments provide for a mixed classical and quantum methodology that simulates a quantum circuit corresponding to a quantum algorithm. In the embodiment, the simulation gives an idealized account of the state of the quantum algorithm at each step of execution. In the embodiment, the quantum circuit corresponds to a set of quantum logic gates performing the steps of the quantum algorithm.

In the embodiment, the state of all qubits is initialized in the basis state |0>. In the embodiment, at each step of the simulated quantum circuit, quantum logic gates manipulate a state of a qubit.

The depth of a quantum circuit is the number of time steps required to perform the quantum algorithm corresponding to the quantum circuit. The illustrative embodiments recognize that error propagation in quantum computers can be minimized by reducing the depth of the quantum circuit.

The illustrative embodiments recognize that an effective way to reduce the depth of the quantum circuit is to eliminate unnecessary operations. For example, a controlled NOT gate is a quantum logic gate that acts on two qubits, a control qubit and a target qubit. A controlled NOT gate flips the target qubit if and only if the control qubit is in the state |1 [symbol] . Two controlled NOT gates occurring back-to-back on the same two qubits results in no change to the target qubit. However, executing the two controlled NOT gates on the quantum processor allows the respective errors of the quantum logic gates to accumulate.

In an embodiment, a quantum algorithm is provided to a quantum circuit compiler application and the quantum circuit compiler application creates a simulation of a quantum circuit performing the steps of the algorithm. In the embodiment, the simulation of the quantum circuit includes a set of quantum logic gates acting on a set of qubits. In the embodiment, the simulation of the quantum circuit tracks a statevector of the quantum circuit. A statevector of the quantum circuit includes the state of all qubits in the quantum circuit at a given step. In the embodiment, as the simulator the moves through the steps of the quantum circuit, the statevector changes according to the operations performed by the set of quantum logic gates on the set of qubits.

In the embodiment, the quantum circuit compiler application identifies extraneous or irrelevant quantum logic gates from the set of quantum logic gates and removes the identified quantum logic gates from the simulated quantum circuit.

In an embodiment, the quantum circuit compiler application identifies a set of initialized basis states for a set of qubits of a quantum processor executing the quantum algorithm. In an embodiment, the set of qubits are initialized in the basis state |0>. In the embodiment, the quantum circuit compiler application simulates the set of quantum logic gates acting on the set of qubits. In the embodiment, the set of quantum logic gates manipulate the states of the set of qubits.

In the embodiment, the quantum circuit compiler application determines a state of at least one of the set of qubits after a subset of the set of quantum logic gates. In particular embodiments, the quantum circuit compiler application determines the state of at least one of the set of qubits from the statevector. In the embodiment, the quantum circuit compiler application compares the determined state of the at least one qubit to the initialized state of the at least one qubit. In the embodiment, the quantum circuit compiler application identifies a qubit of the set of qubits having a same or similar determined state to the initialized state of the qubit. In an embodiment, the quantum circuit compiler application compares a state of a qubit before and after a quantum gate.

In the embodiment, the quantum circuit compiler application removes the subset of the set of quantum logic gates from the quantum circuit in response to the qubit having a same or similar determined state to the initialized state of the qubit. In the embodiment, the quantum circuit compiler application transforms a new quantum circuit performing the steps of the quantum algorithm, the new quantum circuit including fewer quantum logic gates than the simulated quantum circuit.

For the clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the example logic gates, qubits, and other circuit components are used in the figures and the illustrative embodiments. In an actual fabrication or circuit, additional structures or component that are not shown or described herein, or structures or components different from those shown but for a similar function as described herein may be present without departing the scope of the illustrative embodiments.

The illustrative embodiments are described with respect to certain types of quantum logic gates, qubits, quantum processors, quantum circuits, and applications only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

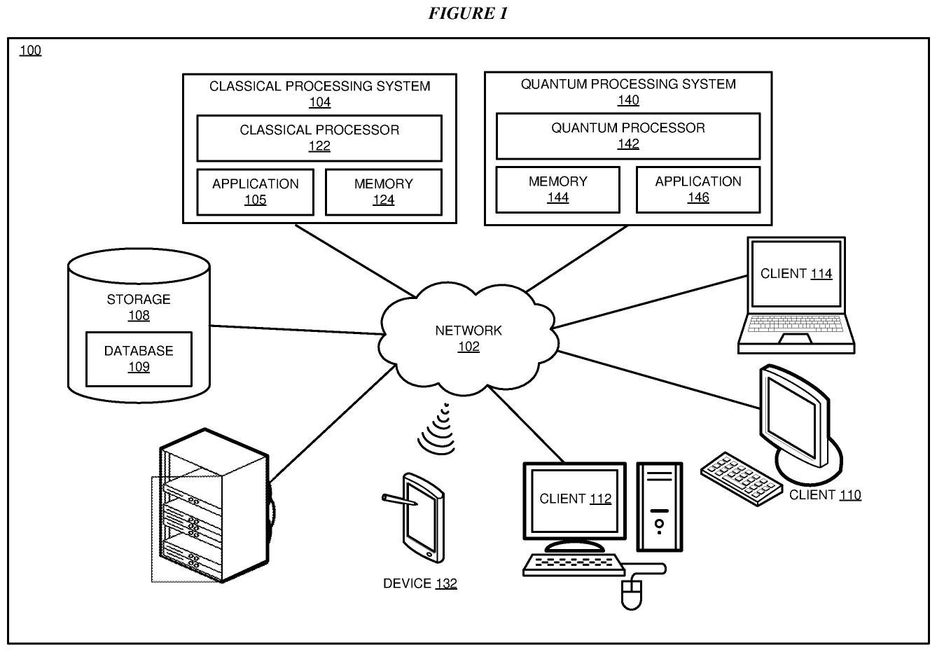

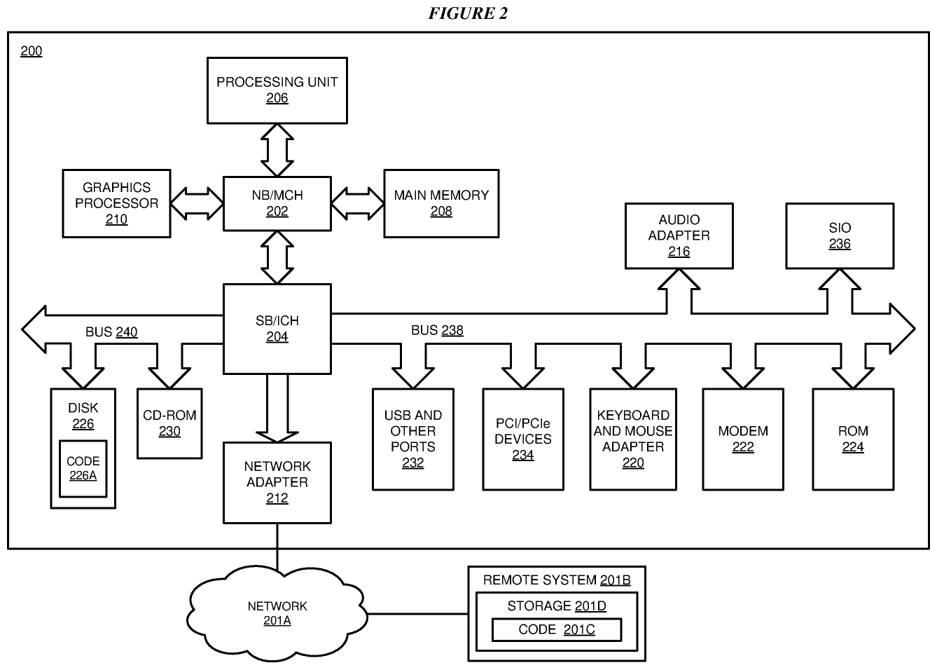

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Classical processing system 104 couples to network 102. Classical processing system 104 is a classical processing system. Software applications may execute on any quantum data processing system in data processing environment 100. Any software application described as executing in classical processing system 104 in FIG. 1 can be configured to execute in another data processing system in a similar manner. Any data or information stored or produced in classical processing system 104 in FIG. 1 can be configured to be stored or produced in another data processing system in a similar manner. A classical data processing system, such as classical processing system 104, may contain data and may have software applications or software tools executing classical computing processes thereon.

Server 106 couples to network 102 along with storage unit 108. Storage unit 108 includes a database 109 configured to store statevectors, quantum algorithms, qubit parameters, quantum gate parameters, and quantum circuit models. Server 106 is a conventional data processing system. Quantum processing system 140 couples to network 102. Quantum processing system 140 is a quantum data processing system. Software applications may execute on any quantum data processing system in data processing environment 100. Any software application described as executing in quantum processing system 140 in FIG. 1 can be configured to execute in another quantum data processing system in a similar manner. Any data or information stored or produced in quantum processing system 140 in FIG. 1 can be configured to be stored or produced in another quantum data processing system in a similar manner. A quantum data processing system, such as quantum processing system 140, may contain data and may have software applications or software tools executing quantum computing processes thereon.

Clients 110, 112, and 114 are also coupled to network 102. A conventional data processing system, such as server 106, or client 110, 112, or 114 may contain data and may have software applications or software tools executing conventional computing processes thereon.

Only as an example, and without implying any limitation to such architecture, FIG. 1 depicts certain components that are usable in an example implementation of an embodiment. For example, server 106, and clients 110, 112, 114, are depicted as servers and clients only as example and not to imply a limitation to a client-server architecture. As another example, an embodiment can be distributed across several conventional data processing systems, quantum data processing systems, and a data network as shown, whereas another embodiment can be implemented on a single conventional data processing system or single quantum data processing system within the scope of the illustrative embodiments. Conventional data processing systems 106, 110, 112, and 114 also represent example nodes in a cluster, partitions, and other configurations suitable for implementing an embodiment.

Device 132 is an example of a conventional computing device described herein. For example, device 132 can take the form of a smartphone, a tablet computer, a laptop computer, client 110 in a stationary or a portable form, a wearable computing device, or any other suitable device. Any software application described as executing in another conventional data processing system in FIG. 1 can be configured to execute in device 132 in a similar manner. Any data or information stored or produced in another conventional data processing system in FIG. 1 can be configured to be stored or produced in device 132 in a similar manner.

Server 106, storage unit 108, classical processing system 104, quantum processing system 140, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 106 may provide data, such as boot files, operating system images, and applications to clients 110, 112, and 114. Clients 110, 112, and 114 may be clients to server 106 in this example. Clients 110, 112, 114, or some combination thereof, may include their own data, boot files, operating system images, and applications. Data processing environment 100 may include additional servers, clients, and other devices that are not shown.

In the depicted example, memory 124 may provide data, such as boot files, operating system images, and applications to classical processor 122. Classical processor 122 may include its own data, boot files, operating system images, and applications. Data processing environment 100 may include additional memories, quantum processors, and other devices that are not shown. Memory 124 includes application 105 that may be configured to implement one or more of the classical processor functions described herein for compilation of quantum algorithms on a hybrid classical-quantum computing system in accordance with one or more embodiments.

In the depicted example, memory 144 may provide data, such as boot files, operating system images, and applications to quantum processor 142. Quantum processor 142 may include its own data, boot files, operating system images, and applications. Data processing environment 100 may include additional memories, quantum processors, and other devices that are not shown. Memory 144 includes application 146 that may be configured to implement one or more of the quantum processor functions described herein in accordance with one or more embodiments.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a conventional client data processing system and a conventional server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a conventional computer, such as classical processing system 104, server 106, or clients 110, 112, and 114 in FIG. 1, or another type of device in which computer usable program code or instructions implementing the processes may be located for the illustrative embodiments.

Data processing system 200 is also representative of a conventional data processing system or a configuration therein, such as conventional data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

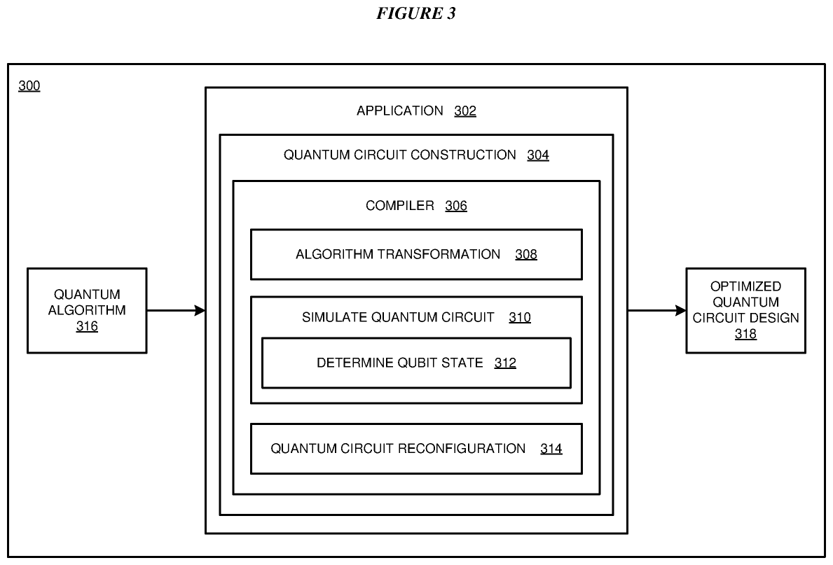

With reference to FIG. 3, this figure depicts an example configuration of constant folding for compilation of quantum algorithms in accordance with an illustrative embodiment. The example embodiment includes an application 302. In a particular embodiment, application 302 is an example of application 105 in FIG. 1. Application 302 includes a quantum circuit construction component 304. Quantum circuit construction component 306 compiles an output quantum circuit design 318 in accordance with an example method described herein. Compiler component 306 is configured to transform an input quantum algorithm 316 into an optimized quantum circuit design 318. Component 306 includes an algorithm transformation component 308, quantum circuit simulation component 310, and quantum circuit reconfiguration component 314.

Component 308 transforms the quantum algorithm code into a first quantum circuit design corresponding to the operations performed by the quantum algorithm. In an embodiment, component 308 analyzes the first quantum circuit to determine the set of qubits and the set of quantum gates used in the first quantum circuit. For example, component 308 can execute a calibration operation. In an embodiment, a calibration operation performs a set of operations on a plurality of qubits Q1, Q2, Q3, . . . , Qn of the quantum processor. In an embodiment, the calibration operation performs a method of randomized benchmarking on the plurality of qubits. For example, calibration operation can perform a set of pre-determined operations on a plurality of qubits of the quantum processor. The set of pre-determined operations generate a set of values for each qubit in response to performing the set of pre-determined operations. In an embodiment, calibration operator compares the set of values for each qubit to an expected answer of at least one of the set of pre-determined operations.

In an embodiment, calibration operation returns a set of qubit parameter values for the plurality of qubits of the quantum processor. For example, qubit coherence time, qubit relaxation time, measurement error, and other qubit parameter values can be determined by the calibration operation. Each qubit of the quantum processor can include a subset of the set of parameter values. For example, qubit Q1 can include associated parameter values P1, P2, . . . , Pn, etc. These examples of qubit parameter values are not intended to be limiting. From this disclosure, those of ordinary skill in the art will be able to conceive of many other qubit parameter values suitable for calibrating a set of qubits and the same are contemplated within the scope of the illustrative embodiments.

In an embodiment, calibration operation returns a set of quantum gate parameters. For example, calibration operation can return a parameter corresponding to an error rate for each quantum gate in the quantum processor. In an embodiment, calibration operation returns a parameter corresponding to an error rate for each one and two qubit gate (primitive gate) in the quantum processor.

Component 308 analyzes a set of quantum gate parameters. In an embodiment, quantum gate parameters correspond to the set of qubits forming the quantum gate and the layout of the qubits on the quantum processor. In an embodiment, calibration operation returns a set of quantum gate parameters values for a plurality of quantum gates of the quantum processor. For example, gate error rates, gate speeds, gate cross talk matrix, and other quantum gate parameter values can be determined by the calibration operation. Each quantum gate of the quantum processor can include a subset of the set of quantum gate parameter values. These examples of quantum gate parameters are not intended to be limiting. From this disclosure, those of ordinary skill in the art will be able to conceive of many other quantum gate parameter values suitable for calibrating a set of quantum gates and the same are contemplated within the scope of the illustrative embodiments.

Component 314 reconfigures the quantum circuit in accordance with at least one of a set of acceptability criteria. In an embodiment, component 314 determines a qubit state to be within a threshold quantum fidelity of an acceptable state. For example, component 314 can determine first qubit includes a state within ninety-seven percent quantum fidelity with basis state |0 [symbol] . In an embodiment, component 314 determines a quantum fidelity of qubit states before and after a quantum logic gate meets an acceptability criterion. For example, component 314 can determine a qubit state before the quantum logic gate meets a threshold quantum fidelity criterion of at least ninety-five percent with a qubit state after the quantum logic gate.

In response to determining a qubit state meets an acceptability criterion, component 314 removes extraneous gates from the set of quantum logic gates. In an embodiment, component 314 removes a subset of the set of quantum logic gates. For example, component 314 can remove all of the quantum logic gates between the determined qubit state and the initialized state.

In an embodiment, component 314 determines a second determined qubit state fails to meet an acceptability criterion. In response to determining a qubit state fails to meet an acceptability criterion, component 314 leaves the set of quantum gates unchanged. In another embodiment, component 314 determines a second determined qubit state

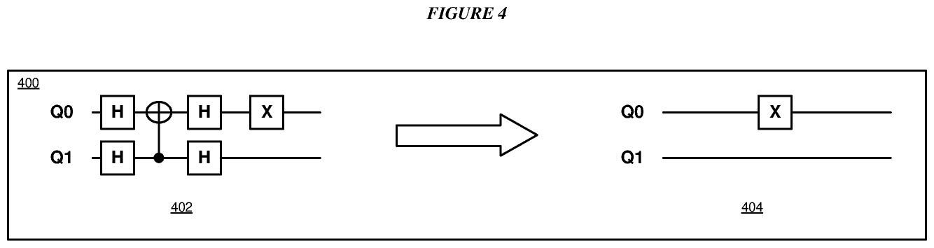

With reference to FIG. 4, this figure depicts an example reconfiguration step in accordance with an illustrative embodiment. Configuration 400 includes a first circuit diagram 402 and a second circuit diagram 404. In an embodiment, application 105 transforms a quantum algorithm into circuit diagrams 402, 404. In an embodiment, component 310 simulates circuit diagram 402. Both Q0 and Q1 are initialized in the state |0 [symbol] in circuit diagram 402. A Hadamard gate acts on one qubit and rotates the state |0 [symbol] to a superposition of states

$$\frac{\vert 0 〉 + \vert 1 〉}{\sqrt{2}} .$$

A controlled NOT gate acts on two qubits, a control qubit and a target qubit. A controlled NOT gate flips the target qubit if and only if the control qubit is in the state |1 [symbol] . A Pauli X gate acts on one qubit and flips the qubit from basis state |0 [symbol] to basis state |1 [symbol] and vice versa.

Hadamard gates act on Q0 and Q1 to rotate the states of Q0 and Q1 from state |0 [symbol] to state

$$\frac{\vert 0 〉 + \vert 1 〉}{\sqrt{2}} .$$

Next, a controlled NOT gate acts on Q0, target qubit, and Q1, control qubit. Since Q1 is not in the state |1 [symbol] , the controlled NOT gate does not flip qubit Q0. Next, Hadamard gates act on Q0 and Q1 to rotate the states of Q0 and Q1 from state

$$\frac{\vert 0 〉 + \vert 1 〉}{\sqrt{2}}$$

to state |0 [symbol] . At this stage of the circuit diagram 402, Q0 is in the state |0 [symbol] , the same state Q0 is in before being acted on by any gates. Next, a Pauli X gate acts on qubit Q0 to flip the state from |0 [symbol] to state |1 [symbol] .

During simulation of the first circuit diagram 402, component 312 determines the state of at least one of the qubits. For example, component 312 can determine qubit Q0 is in the basis state |0 [symbol] after the second set of Hadamard gates. Component 314 analyzes the determined states to determine whether the determined states meet an acceptability criterion. For example, component 314 can compare the determined state to a basis state. In another example, component 314 can determine whether the determined state is within a threshold quantum fidelity of a basis state, such as at least ninety-seven percent quantum fidelity.

In response to the determined state meeting an acceptability criterion, component 314 reconfigures the quantum circuit diagram for the quantum algorithm. For example, component 314 can determine Q0 is in the state |0 [symbol] after the second set of Hadamard gates. Component 314 determines qubit Q0 is in the same state as before the Hadamard gates. Component 314 determines all the Hadamard gates and the controlled NOT gates are extraneous gates because Q0 is in the same state as before the set of extraneous quantum logic gates. Component 314 reconfigures the first circuit diagram 402 by removing the set of extraneous quantum logic gates, thus producing the second circuit diagram 404.

These examples of quantum logic gates are not intended to be limiting. From this disclosure those of ordinary skill in the art will be able to conceive of many other quantum logic gates suitable for manipulating a state of a qubit and the same are contemplated within the scope of the illustrative embodiments.

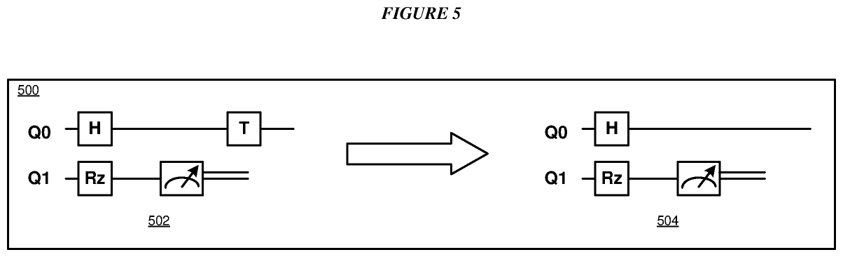

With reference to FIG. 5, this figure depicts an example reconfiguration step in accordance with an illustrative embodiment. Configuration 500 includes a first circuit diagram 502 and a second circuit diagram 504. In an embodiment, application 105 transforms a quantum algorithm into circuit diagrams 502, 504. In an embodiment, component 310 simulates circuit diagram 502. Both Q0 and Q1 are initialized in the state |0 [symbol] in circuit diagram 502. A Pauli Z gate acts on one qubit and rotates the basis state |1 [symbol] to −|1 [symbol] and leaves basis state |0 [symbol] unchanged. A measurement writes the state to a classical bit, i.e., |1 [symbol] to 1 and |0 [symbol] to 0. A Toffoli gate acts on three qubits, two control qubits and one target qubit. A Toffoli gate flips the target qubit if and only if the two control qubits are in state |1 [symbol] .

Hadamard gate acts on Q0 to rotate the state of Q0 from state |0 [symbol] to state

$$\frac{\vert 0 〉 + \vert 1 〉}{\sqrt{2}} .$$

Next, a Pauli Z gate acts on Q1. Since Q1 is in the state |0 [symbol] , the Pauli Z gate leaves the state of Q1 unchanged. Next, a measurement is taken on Q1. At this stage of the circuit diagram 402, Q1 is in the state |0 [symbol] , so the measurement returns a classical bit with value 0. In an embodiment, application 105 writes the value of the measurement to a classical bit, C. Next, a Toffoli gate acts on target qubit Q0. In an embodiment, the Toffoli gate only acts on Q0 if C has a value of 1.

In an embodiment, compiler 306 determines the value of C will always be 0 because of the initialized state and the Pauli Z gate. Component 314 analyzes the determined states to determine whether the determined states meet an acceptability criterion. For example, component 314 can compare the measurement to a conditional statement. For example, failing to match the conditional statement meets an acceptability criterion

In response to the determined state meeting an acceptability criterion, component 314 reconfigures the quantum circuit diagram for the quantum algorithm. For example, component 314 can determine Q1 is always in the state |0 [symbol] after the measurement. Component 314 determines the Toffoli gate is an extraneous gate because Q1 is always in the state |0 [symbol] after the measurement so the conditional statement is not satisfied. Component 314 reconfigures the first circuit diagram 502 by removing the set of extraneous quantum logic gates, thus producing the second circuit diagram 504.

These examples of quantum logic gates are not intended to be limiting. From this disclosure those of ordinary skill in the art will be able to conceive of many other quantum logic gates suitable for manipulating a state of a qubit and the same are contemplated within the scope of the illustrative embodiments.

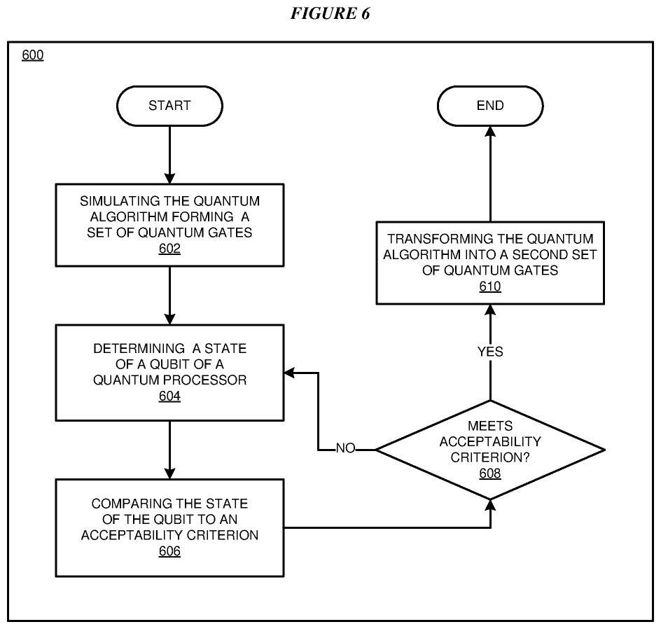

With reference to FIG. 6, this figure depicts a flowchart of an example method for constant folding for compilation of quantum algorithms in accordance with an illustrative embodiment. Application 105 performs method 600 in an embodiment. In block 602, application 105 simulates a quantum algorithm forming a set of quantum gates performing operations of the quantum algorithm. In block 604, application 105 determines a state of a qubit performing at least one of the set of quantum gates. In block 606, application 105 compares the state of the qubit to an acceptability criterion. In block 608, application 105 determines whether the state of the qubit meets an acceptability criterion. In response to determining the state of the qubit fails to meet an acceptability criterion (NO path of block 608), application 105 returns to block 604 to determine another state of the same qubit or a state of another qubit. In response to determining the state meets an acceptability criterion (YES path of block 608), application 105 moves to block 610. In block 610, application 105 transforms the quantum algorithm into a second set of quantum gates, the second set of quantum gates having fewer total number of quantum gates than the first set of quantum gates. Application 105 ends process 600 thereafter.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
forming a first set of quantum gates, the first set of quantum gates arranged to simulate a quantum algorithm;
determining, after performing a first subset of the first set of quantum gates, a state of a qubit of a quantum processor;
comparing the state of the qubit to an acceptability criterion;
removing, in response to determining the state meets an acceptability criterion, a second subset of the set of quantum gates; and
forming, in response to removing the second subset of the set of quantum gates, a second set of quantum gates, the second set of quantum gates arranged to simulate the quantum algorithm.

2. The method of claim 1, further comprising:
removing the first subset of the first set of quantum gates to form the second set of quantum gates.

3. The method of claim 1, further comprising:
removing the subset of the first set of quantum gates to form the second set of quantum gates.

4. The method of claim 1, further comprising:
determining, in response to determining the state meets an acceptability criterion, a subset of the first set of quantum gates are extraneous quantum gates.

5. The method of claim 4, further comprising:
removing the subset of quantum gates from the first set of quantum gates.

6. The method of claim 1, further comprising:
executing the quantum algorithm with the second set of quantum gates.

7. The method of claim 1, wherein the acceptability criterion is a conditional statement for a quantum gate of the first set of quantum gates.

8. The method of claim 1, wherein the acceptability criterion is a threshold quantum fidelity.

9. A computer usable program product comprising a computer-readable storage device, and program instructions stored on the storage device, the stored program instructions comprising:
program instructions to form a first set of quantum gates, the first set of quantum gates arranged to simulate a quantum algorithm;
program instructions to determine, after performing a first subset of the first set of quantum gates, a state of a qubit of a quantum processor;
program instructions to compare the state of the qubit to an acceptability criterion;
program instructions to remove, in response to determining the state meets an acceptability criterion, a second subset of the set of quantum gates; and
program instructions to form, in response to removing the second subset of the set of quantum gates, a second set of quantum gates, the second set of quantum gates arranged to simulate the quantum algorithm.

10. The computer usable program product of claim 9, the stored program instructions further comprising:
program instructions to remove the first subset of the first set of quantum gates to form the second set of quantum gates.

11. The computer usable program product of claim 9, the stored program instructions further comprising:
program instructions to remove the subset of the first set of quantum gates to form the second set of quantum gates.

12. The computer usable program product of claim 9, the stored program instructions further comprising:
program instructions to determine, in response to determining the state meets an acceptability criterion, a subset of the first set of quantum gates are extraneous quantum gates.

13. The computer usable program product of claim 12, the stored program instructions further comprising:
program instructions to remove the subset of quantum gates from the first set of quantum gates.

14. The computer usable program product of claim 9, the stored program instructions further comprising:
program instructions to execute the quantum algorithm with the second set of quantum gates.

15. The computer usable program product of claim 9, wherein the acceptability criterion is a conditional statement for a quantum gate of the first set of quantum gates.

16. The computer usable program product of claim 9, wherein the acceptability criterion is a threshold quantum fidelity.

17. The computer usable program product of claim 9, wherein the stored program instructions are stored in a computer readable storage device in a data processing system, and wherein the computer usable code is transferred over a network from a remote data processing system.

18. The computer usable program product of claim 9, wherein the stored program instructions are stored in a computer readable storage device in a server data processing system, and wherein the computer usable code is downloaded over a network to a remote data processing system for use in a computer readable storage device associated with the remote data processing system.

19. A computer system comprising a processor, a computer-readable memory, and a computer-readable storage device, and program instructions stored on the storage device for execution by the processor via the memory, the stored program instructions comprising:
program instructions to form a first set of quantum gates, the first set of quantum gates arranged to simulate a quantum algorithm;
program instructions to determine, after performing a first subset of the first set of quantum gates, a state of a qubit of a quantum processor;
program instructions to compare the state of the qubit to an acceptability criterion;
program instructions to remove, in response to determining the state meets an acceptability criterion, a second subset of the set of quantum gates; and
program instructions to form, in response to removing the second subset of the set of quantum gates, a second set of quantum gates, the second set of quantum gates arranged to simulate the quantum algorithm.

20. The computer system of claim 19, the stored program instructions further comprising:
program instructions to remove the first subset of the first set of quantum gates to form the second set of quantum gates
